(19) United States
(12) Patent Application Publication
(10) Pub. No.: US 2014/0374503 A1
(43) Pub. Date: Dec. 25, 2014

(54) LIQUID DISCHARGE HEAD, RECORDING DEVICE USING SAME, AND PIEZOELECTRIC ACTUATOR SUBSTRATE FOR USE THEREIN

(71) Applicant: KYOCERA Corporation, Kyoto-shi, Kyoto (JP)

(72) Inventors: Kenichi Yoshimura, Kirishima-shi (JP); Wataru Ikeuchi, Kirishima-shi (JP)

(73) Assignee: KYOCERA Corporation, Kyoto-shi, Kyoto (JP)

(21) Appl. No.: 14/369,376

(22) PCT Filed: Dec. 27, 2012
(86) PCT No.: PCT/JP2012/083905

§ 371 Date: Jun. 27, 2014

(30) Foreign Application Priority Data
Dec. 27, 2011 (JP) 2011-285758

(51) Int. Cl. B05B 17/06

(52) U.S. Cl. CPC B05B 17/0607
USPC 239/102.2

(57) ABSTRACT

A liquid discharge head has plates constituting a flow passage member, and a piezoelectric actuator substrate and the flow passage member are joined satisfactorily. A liquid discharge head includes a flow passage member laminated a plurality of flat plates, having a pressurizing chamber, a plurality of discharge holes, and a common flow passage, and a piezoelectric actuator substrate laminated on the flow passage member, on which a plurality of displacement elements are disposed. On one principal plane of the piezoelectric actuator substrate, a plurality of connection electrodes to which driving signals of the displacement elements are supplied are disposed, and the number of the connection electrodes per unit area disposed in a first region D1 not overlapping the common flow passage is greater than the number of the connection electrodes per unit area disposed in a second region D2 overlapping the common flow passage.

### TECHNICAL FIELD

The present invention relates to a liquid discharge head for discharging liquid droplets, a recording device using the same, and a piezoelectric actuator substrate for use therein.

### BACKGROUND ART

Recently, printing devices using an inkjet recording system such as inkjet printers and inkjet plotters are widely used not only as general consumer printers, but also for industrial uses including formation of an electronic circuit, production of a color filter for a liquid crystal display, and production of an organic EL display.

Such a printing device based on the inkjet system is equipped with a liquid discharge head for discharging a liquid, as a printing head. In this sort of printing heads, thermal head system and piezoelectric system are generally known. In the thermal head system, a heater as pressuring means in an ink flow passage filled with ink, in which the ink is heated and boiled by the heater, and the ink is pressurized by air bubbles occurring in the ink flow passage, and the ink is discharged as liquid droplets from ink discharge holes. In the piezoelectric system, apart of wall of ink flow passage filled with ink is bent and displaced by a displacement element to mechanically pressurize the ink in the ink flow passage, and thus the ink is discharged as liquid droplets from ink discharge holes.

Such a liquid discharge head employs a serial system in which recording is conducted while the liquid discharge head is moved in the direction (main scanning direction) perpendicular to the transport direction (vertical scanning direction) of the recording medium, or a line system in which recording is conducted on the recording medium being transported in the vertical scanning direction while the liquid discharge head which is long in the main scanning direction is fixed. The line system is advantageous in that high speed recording is possible because the liquid discharge head does not need to be moved as is in the serial system.

In light of this, there is known a liquid discharge head that is long in one direction, formed by laminating a flow passage member having a manifold (common flow passage) and discharge holes connecting from the manifold via respective pressurizing chambers, and a piezoelectric actuator substrate having a plurality of displacement elements disposed to cover the respective pressurizing chambers (for example, see Patent Document 1). In this flow passage member, flow passages are formed by laminating metal plates in which a large number of holes are open. In this liquid discharge head, pressurizing chambers respectively connecting with a plurality of the discharge holes are arranged in a matrix form, and by displacing a displacement element of an actuator unit provided to cover the same, ink is discharged from each discharge hole and printing at a resolution of 600 dpi in the main scanning direction is enabled.

### PRIOR ART DOCUMENT

### Patent Document

Patent Document 1: Japanese Unexamined Patent Publication No. 2003-305852

### SUMMARY OF INVENTION

### Technical Problem

In manufacturing of the liquid discharge head described in Patent Document 1, by forming the connection electrode at a position not overlapping the pressurizing chamber on the electrode of the piezoelectric actuator substrate at the time of laminating and joining a plurality of the plates constituting the flow passage member and the piezoelectric actuator substrate via adhesive layers, the pressure of lamination is applied mainly on the part where the connection electrode is formed, so that the piezoelectric actuator substrate directly above the pressurizing chamber is less likely to be broken during lamination. This connection electrode may also be used for electrical connection with outside. On the occasion, the connection electrode is positioned in the region overlapping the region where the common flow passage is formed in some cases, and the connection electrode is positioned in the region overlapping the region where the common flow passage is not formed, depending on the arrangement of the common flow passage.

Regardless of whether the aforementioned connection electrode is provided, since the plate between the common flow passage and the piezoelectric actuator substrate can bend toward the common flow passage side upon application of pressure to the piezoelectric actuator substrate during lamination, interlayer joining between the plate and the piezoelectric actuator substrate, or interlayer joining between the plates in that part is insufficient, and liquid enters the interlayer from the flow passage. This leads the risk of variation in flow passage characteristics or mixture of different kinds of liquids.

Therefore, it is an object of the present invention to provide a liquid discharge head in which plates constituting a flow passage member, and a piezoelectric actuator substrate and the flow passage member are joined satisfactorily, a recording device using the same, and a piezoelectric actuator substrate for use therein.

### Solution to Problem

A liquid discharge head of the present invention includes a flow passage member laminated a plurality of flat plates, having a plurality of pressurizing chambers opening in a plane, a plurality of discharge holes respectively connecting with a plurality of the pressurizing chambers, and a common flow passage commonly connecting with a plurality of the pressurizing chambers; and a piezoelectric actuator substrate laminated on the plane of the flow passage member, disposed with a plurality of displacement elements, each displacement element containing at least one piezoelectric ceramic layer and a pair of electrodes disposed on each side with the piezoelectric ceramic layer interposed therebetween, wherein on one principal plane of the piezoelectric actuator substrate, a plurality of connection electrodes to which respective driving signals of a plurality of the displacement elements are supplied are disposed, and the number of the connection electrodes per unit area disposed in a first region that is a region not overlapping the common flow passage of the one principal plane, in a planar view of the liquid discharge head is greater than the number of the connection electrodes per unit area disposed in a second region that is a region overlapping the common flow passage of the one principal plane.

Also, a liquid discharge head of the present invention includes a flow passage member laminated a plurality of flat plates, having a plurality of pressurizing chambers opening in a plane, a plurality of discharge holes respectively connecting with a plurality of the pressurizing chambers, and a common flow passage commonly connecting with a plurality of the pressurizing chambers; and a piezoelectric actuator substrate laminated on the plane of the flow passage member, disposed with a plurality of displacement elements, each displacement element containing at least one piezoelectric ceramic layer and a pair of electrodes disposed on each side with the piezoelectric ceramic layer interposed therebetween, wherein on one principal plane of the piezoelectric actuator substrate, a plurality of connection electrodes to which respective driving signals of a plurality of the displacement elements are supplied, and a plurality of dummy connection electrodes are disposed, and the number of the dummy connection electrodes per unit area disposed in a first region that is a region not overlapping the common flow passage of the one principal plane, in a planar view of the liquid discharge head is greater than the number of the dummy connection electrodes per unit area disposed in a second region that is a region overlapping the common flow passage of the one principal plane.

Also, a liquid discharge head of the present invention includes a flow passage member laminated a plurality of flat plates, having a plurality of pressurizing chambers opening in a plane, a plurality of discharge holes respectively connecting with a plurality of the pressurizing chambers, and a common flow passage commonly connecting with a plurality of the pressurizing chambers; and a piezoelectric actuator substrate laminated on the plane of the flow passage member, disposed with a plurality of displacement elements, each displacement element containing at least one piezoelectric ceramic layer and a pair of electrodes disposed on each side with the piezoelectric ceramic layer interposed therebetween, wherein on one principal plane of the piezoelectric actuator substrate, a plurality of connection electrodes to which respective driving signals of a plurality of the displacement elements are supplied, and a plurality of dummy connection electrodes are disposed, and the number of the connection electrodes and the dummy connection electrodes per unit area disposed in a first region that is a region not overlapping the common flow passage of the one principal plane, in a planar view of the liquid discharge head is greater than the number of the connection electrodes and the dummy connection electrodes per unit area disposed in a second region that is a region overlapping the common flow passage of the one principal plane.

Further, a recording device of the present invention includes the liquid discharge head, a transport section for transporting a recording medium to the liquid discharge head, and a control section for controlling the liquid discharge head.

Further, a piezoelectric actuator substrate for a liquid discharge head of the present invention includes a plurality of displacement elements, each displacement element containing at least one piezoelectric ceramic layer and a pair of electrodes disposed on each side with the piezoelectric ceramic layer interposed therebetween, wherein on one principal plane of the piezoelectric actuator substrate, a plurality of connection electrodes to which respective driving signals of a plurality of the displacement elements are supplied are disposed, and the one principal plane is divided into a first region not overlapping a common flow passage when it is used in the liquid discharge head and a second region overlapping the same, and the number of the connection electrodes per unit area disposed in the first region is greater than the number of the connection electrodes per unit area disposed in the second region.

### Advantageous Effect of Invention

According to the present invention, it is possible to provide a liquid discharge head in which plates constituting a flow passage member, and a piezoelectric actuator substrate and the flow passage member are joined satisfactorily.

### BRIEF DESCRIPTION OF DRAWING

FIG. 1 is a schematic configuration view of a color inkjet printer which is a recording device including a liquid discharge head according to one embodiment of the present invention.

FIG. 2 is a plan view of a flow passage member and a piezoelectric actuator substrate constituting the liquid discharge head of FIG. 1.

FIG. 3 is an enlarged view of the region surrounded by the dashed line in FIG. 2, in which part of flow passage is omitted for explanation.

FIG. 4 is an enlarged view of FIG. 3.

FIG. 5 is an enlarged view of the region surrounded by the dashed line in FIG. 2, in which part of flow passage is omitted for explanation.

FIG. 6 is a longitudinal section view along the line V-V in FIG. 3, in the state that a connection member is connected.

FIG. 7 is an enlarged plan view of the liquid discharge head shown in FIGS. 2 to 6.

FIG. 8(a) is a schematic view illustrating the arrangement of connection electrodes of the liquid discharge head shown in FIGS. 2 to 7, and FIGS. 8(b) to 8(c) are schematic views illustrating the arrangements of connection electrodes according to other embodiments of the present invention.

FIGS. 9(a) and 9(b) are schematic views illustrating the arrangements of connection electrodes in other embodiments of the present invention.

### DESCRIPTION OF EMBODIMENT

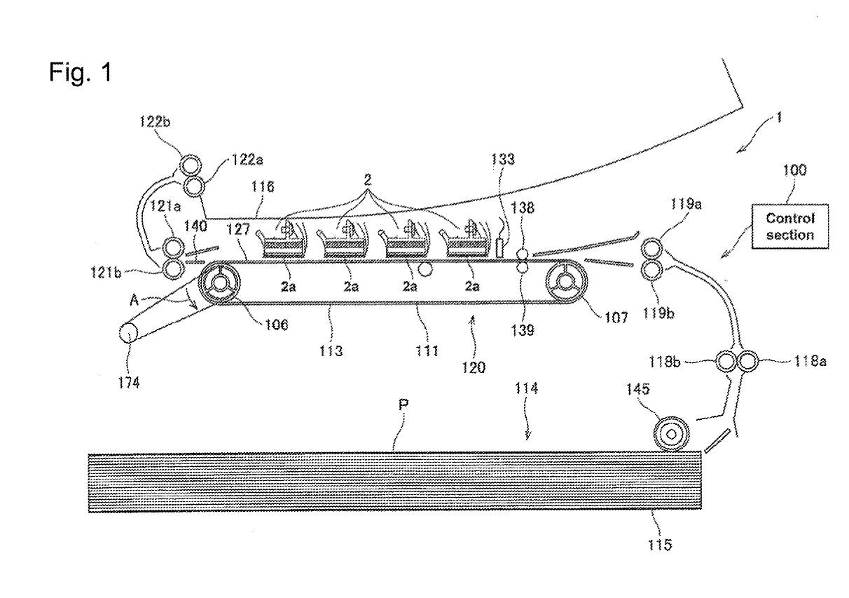

FIG. 1 is a schematic configuration view of a color inkjet printer which is a recording device including a liquid discharge head according to one embodiment of the present invention. This color inkjet printer 1 (hereinafter, referred to as printer 1) has four liquid discharge heads 2. These liquid discharge heads 2 are arranged along a transport direction of a printing sheet P, and each of the liquid discharge head 2 fixed to the printer 1 has an elongated shape in the backward direction from the front of FIG. 1. This lengthwise direction is also called a longitudinal direction.

The printer 1 includes a sheet feed unit 114, a transport unit 120 and a sheet reception unit 116 in sequence along the transport path of the printing sheet P. The printer 1 also includes a control section 100 for controlling operations in respective parts such as the liquid discharge heads 2 and the sheet feed unit 114 of the printer 1.

The sheet feed unit 114 has a sheet storage case 115 capable of storing a plurality of printing sheets P, and a sheet feed roller 145. The sheet feed roller 145 is able to feed out the uppermost printing sheet P one by one, from the printing sheets P that are stacked and stored in the sheet storage case 115.

Between the sheet feed unit 114 and the transport unit 120, two pairs of feeding rollers 118a and 118b, and 119a and 119b are disposed along the transport path of the printing sheet P. The printing sheet P fed out from the sheet feed unit 114 is further fed toward the transport unit 120 while it is guided by these feeding rollers.

The transport unit 120 has an endless transport belt 111 and two belt rollers 106 and 107. The transport belt 111 is wounded around the belt rollers 106 and 107. The length of the transport belt 111 is so adjusted that it is stretched under a predetermined tension when wound around the two belt rollers. As a result, the transport belt 111 is stretched without looseness along the two parallel planes each involving the common tangent line of the two belt rollers. Of these two planes, the plane closer to the liquid discharge heads 2 is a transport plane 127 for transporting the printing sheet P.

To the belt roller 106, a transport motor 174 is connected as shown in FIG. 1. The transport motor 174 is able to rotate the belt roller 106 in the direction of the arrow A. The belt roller 107 can rotate in conjunction with the transport belt 111. Therefore, by driving the transport motor 174 to rotate the belt roller 106, the transport belt 111 moves along the direction of the arrow A.

In the vicinity of the belt roller 107, a nip roller 138 and a nip reception roller 139 are disposed in the manner of nipping the transport belt 111 therebetween. The nip roller 138 is energized downward by a spring that is not illustrated in the drawing. The nip reception roller 139 under the nip roller 138 receives the downwardly energized nip roller 138 via the transport belt 111. These two nip rollers are disposed in a rotatable manner, and rotate in conjunction with the transport belt 111.

The printing sheet P fed out toward the transport unit 120 from the sheet feed unit 114 is nipped between the nip roller 138 and the transport belt 111. As a result, the printing sheet P is pushed against the transport plane 127 of the transport belt 111 and fixed on the transport plane 127. Then the printing sheet P is transported in the direction toward the liquid discharge heads 2 in accordance with the rotation of the transport belt 111. The transport belt 111 may be treated on its outer circumferential face 113 with adhesive silicone rubber. As a result, the printing sheet P can be fixed on the transport plane 127 more securely.

The liquid discharge head 2 has a head body 2a in its lower end part. The bottom face of the head body 2a forms a discharge port face 4-1 provided with a large number of discharge holes.

From the liquid discharge holes 8 provided in each liquid discharge head 2, liquid droplets (ink) of the same color are discharged. Each liquid discharge head 2 is supplied with a liquid from an external liquid tank that is not illustrated in the drawing. Since the liquid discharge holes 8 in each liquid discharge head 2 open on the liquid discharge hole face, and are disposed at equal intervals in one direction (the direction that is parallel with the printing sheet P and is perpendicular to the transport direction of the printing sheet P, or the longitudinal direction of the liquid discharge head 2), it is possible to achieve printing in the one direction without any space. Colors of liquids discharged from respective liquid discharge heads 2 are, for example, magenta (M), yellow (Y), cyan (C) and black (K). Each liquid discharge head 2 is disposed while a slight gap is left between the lower surface of a liquid discharge head body 13 and the transport plane 127 of the transport belt 111.

The printing sheet P conveyed by the transport belt 111 passes through the gap between the liquid discharge head 2 and the transport belt 111. At this time, liquid droplets are discharged toward the top face of the printing sheet P from the head body 2a constituting the liquid discharge head 2. As a result, a color image based on the image data stored by the control section 100 is formed on the top face of the printing sheet P.

Between the transport unit 120 and the sheet reception unit 116, a detachment plate 140, and two pairs of feeding rollers 121a and 121b, and 122a and 122b are disposed. The printing sheet P on which color image is printed is transported to the detachment plate 140 by the transport belt 111. At this time, the printing sheet P is detached from the transport plane 127 by the right end of the detachment plate 140. The printing sheet P is then fed out to the sheet reception unit 116 by the feeding rollers 121a to 122b. In this manner, the printing sheet P after printing is sequentially fed to the sheet reception unit 116 and stacked in the sheet reception unit 116.

Between the nip roller 138 and the liquid discharge head 2 at the most upstream position in the transport direction of the printing sheet P, a sheet face sensor 133 is provided. The sheet face sensor 133 includes a light-emitting device and a light-receiving device, and able to detect the leading end position of the printing sheet P on the transport path. The detection result by the sheet face sensor 133 is sent to the control section 100. The control section 100 is able to control the liquid discharge head 2, the transport motor 174 and so on so that transport of the printing sheet P and printing of image are in synchronization with each other, according to the detection result sent from the sheet face sensor 133.

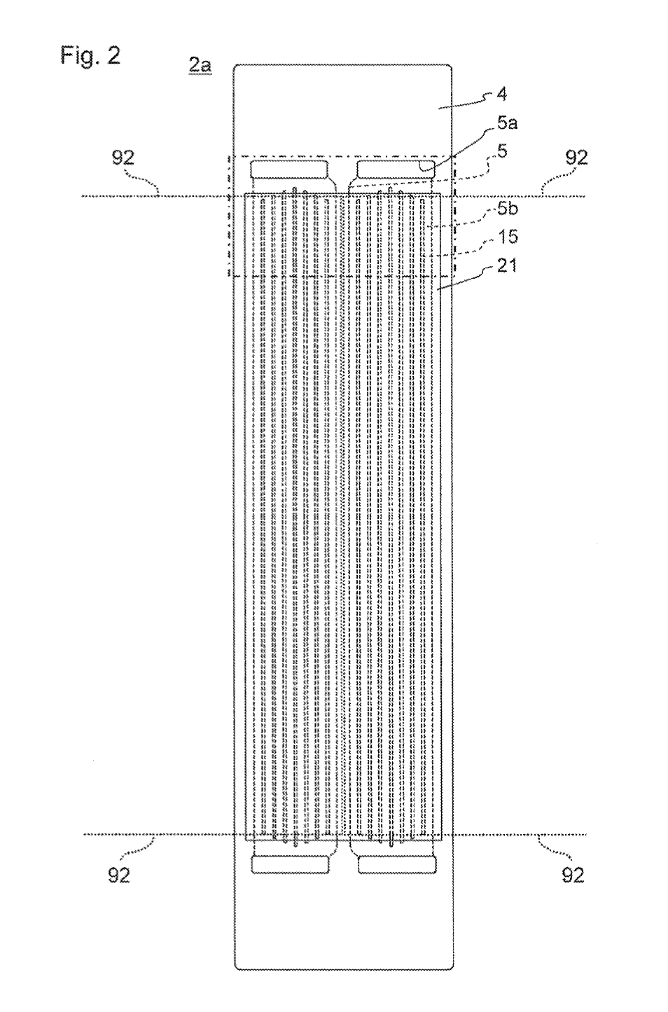

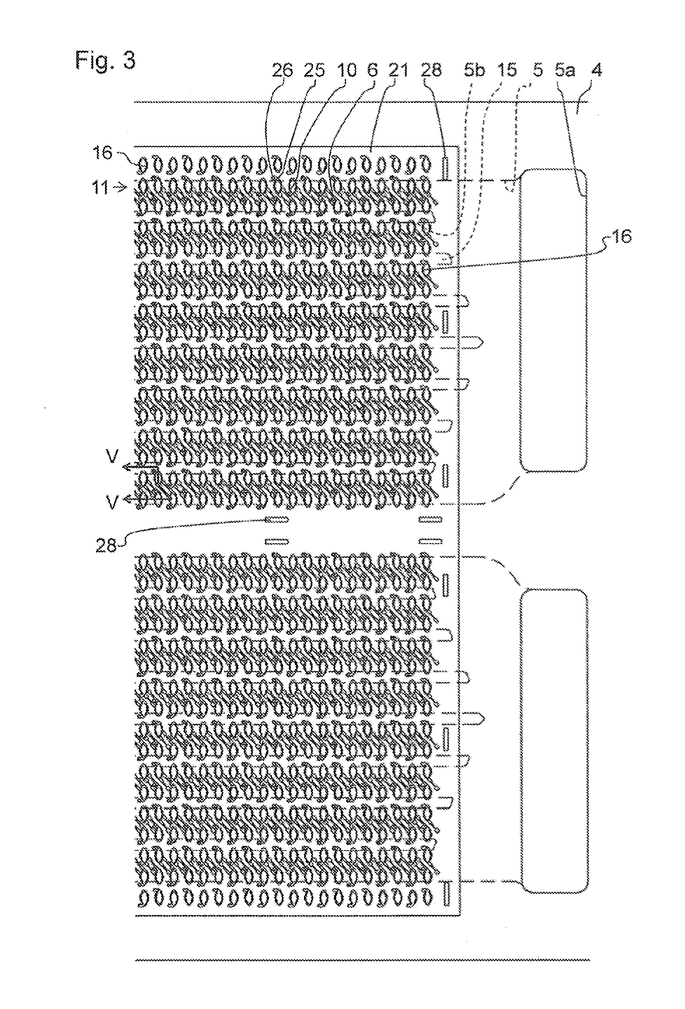

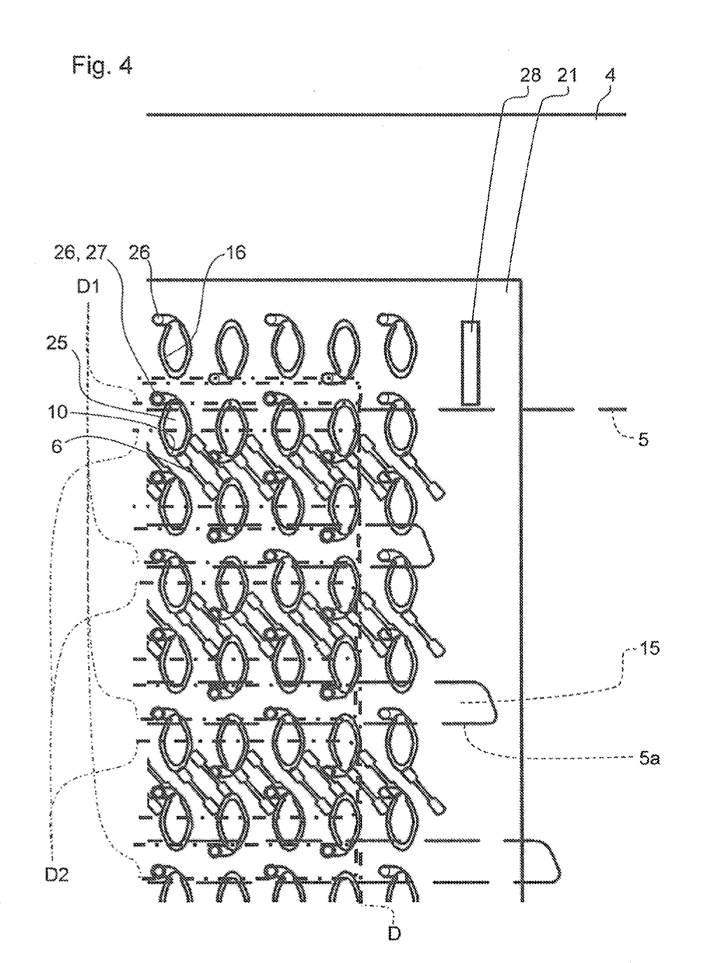

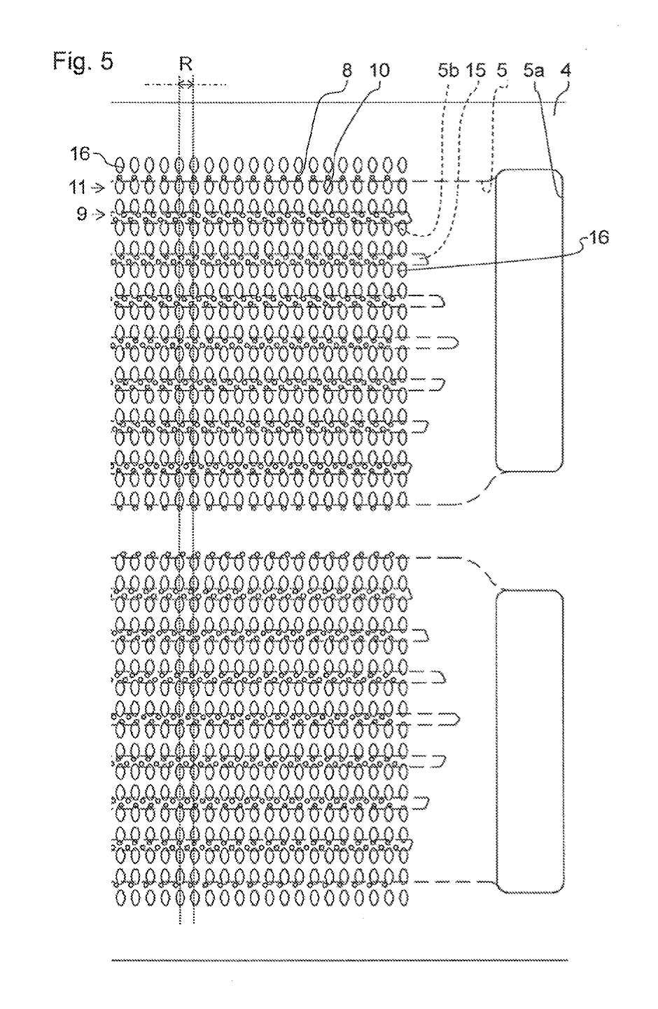

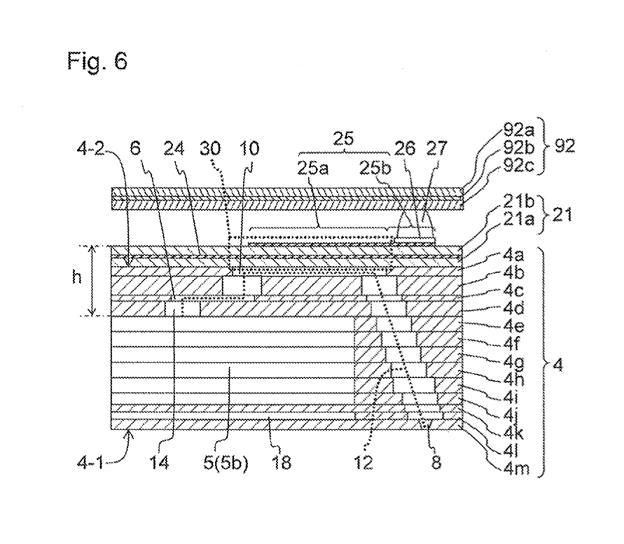

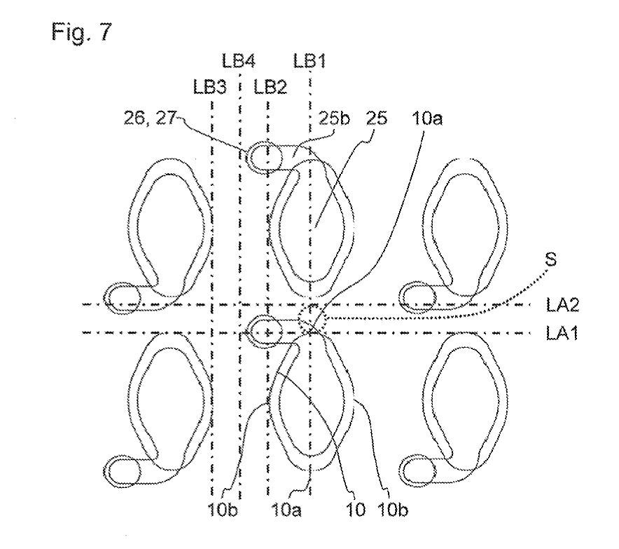

Next, the liquid discharge head 2 of the present invention will be described. FIG. 2 is a plan view of the head body 2a. FIG. 3 is an enlarged view of the region surrounded by the dashed line in FIG. 2, in which part of flow passage is omitted for explanation, and FIG. 4 illustrates a part of FIG. 3 in a further enlarged scale. FIG. 5 is an enlarged view of the region surrounded by the dashed line in FIG. 2, in which part of flow passage that is different from the part in FIG. 3 is omitted for explanation. In FIGS. 3 to 5, the apertures 6, the discharge holes 8, the pressurizing chambers 10 and so on that are located below the piezoelectric actuator substrate 21 and thus should be described in dotted lines are described in solid lines for clarifying the drawings. FIG. 6 is a longitudinal section view along the line V-V in FIG. 3. This drawing illustrates the state after connection with a signal transmission part 92. FIG. 7 is an enlarged plan view of the head body 2a shown in FIGS. 2 to 6, and illustrates the relationships between the pressurizing chamber 10, an individual electrode 25, and a connection land 26 and a connection bump 27 which are connection electrodes.

The liquid discharge head 2 includes a reservoir and a metal housing in addition to the head body 2a. The head body 2a includes a flow passage member 4, and a piezoelectric actuator substrate 21 in which a displacement element (pressurizing part) 30 is incorporated.

The flow passage member 4 constituting the head body 2a has a manifold 5 which is a common flow passage, a plurality of pressurizing chambers 10 connecting with the manifold 5, and a plurality of discharge holes 8 respectively connected with a plurality of the pressurizing chambers 10. The pressurizing chamber 10 opens in the top face of the flow passage member 4, and the top face of the flow passage member 4 forms a pressurizing chamber face 4-2. The top face of the flow passage member 4 has an opening 5a connecting with the manifold 5, and liquid is supplied through this opening 5a.

To the top face of the flow passage member 4, the piezoelectric actuator substrate 21 containing the displacement elements 30 is joined so that the respective displacement elements 30 are situated on the pressurizing chambers 10. To the piezoelectric actuator substrate 21, a signal transmission part 92 such as FPC (Flexible Printed Circuit) for supplying each displacement element 30 with a signal is connected. In FIG. 2, the profile of the signal transmission part 92 at or in the vicinity of the site where the signal transmission part 92 is connected with the piezoelectric actuator substrate 21 is indicated by a dotted line for understanding of the connection state between the two signal transmission parts 92 and the piezoelectric actuator substrate 21. The electrode that is formed in the signal transmission part 92 and is electrically connected with the piezoelectric actuator substrate 21 is disposed in a rectangular form in an end part of the signal transmission part 92. The two signal transmission parts 92 are connected so that respective ends are situated in the center part of the lateral direction of the piezoelectric actuator substrate 21. The two signal transmission parts 92 extend from the center part toward the long side of the piezoelectric actuator substrate 21.

The signal transmission part 92 contains a driver IC mounted therein. The driver IC is mounted in such a manner that it is pushed against a metal housing, and heat of the driver IC is transmitted to the metal housing and diffused outside. A drive signal for driving the displacement element 30 on the piezoelectric actuator substrate 21 is generated inside the driver IC. A signal for controlling generation of a drive signal is generated in the control section 100, and inputted from the end of the signal transmission part 92 opposite to the side where the signal transmission part 92 is connected with the piezoelectric actuator substrate 21. Between the control section 100 and the signal transmission part 92, a wiring substrate or the like provided inside the liquid discharge head 2 is provided as needed.

The head body 2a has the flow passage member 4 in the shape of a flat plate, and one piezoelectric actuator substrate 21 containing the displacement element 30 connected on the flow passage member 4. The piezoelectric actuator substrate 21 has a rectangular planar shape, and is disposed on the top face of the flow passage member 4 so that the longer side of the rectangle conforms with the longitudinal direction of the flow passage member 4.

Inside the flow passage member 4, two manifolds 5 are formed. The manifold 5 has an elongated shape extending from one end part side to the other end part side in the longitudinal direction of the flow passage member 4, and is formed with the opening 5a of manifold opening in the top face of the flow passage member 4 in its both end parts. By supplying the flow passage member 4 with the liquid from the both end parts of the manifold 5, shortage of liquid supply is less likely to occur. Also, it is possible to reduce the difference in pressure loss generated during passage of liquid through the manifold 5 to about half compared with the case where the liquid is supplied from one end of the manifold 5, and thus it is possible to reduce the variation in liquid discharge characteristics.

The manifold 5 is partitioned by partition walls 15 disposed at intervals along the width, at least in a middle part of the longitudinal direction which connects with the pressurizing chamber 10. The partition wall 15 has the same height as the manifold 5 in the middle part of the longitudinal direction, is the middle part being a region connecting with the pressurizing chamber 10. The partition wall 15 completely divides the manifold 5 into a plurality of sub manifolds 5b. With this structure, it is possible to provide the discharge holes 8 and a descender that connects the discharge holes 8 and the pressurizing chamber 10 so that they overlap the partition walls 15 in a planar view.

In FIG. 2, the entire manifold 5 except both end parts is partitioned by the partition walls 15. Besides the above design, the part other than either one of both end parts may be partitioned by the partition walls 15. A partition wall may be disposed in the course in the depth direction of the flow passage member 4 from the opening 5a, while the part near the opening 5a that opens in the top face of the flow passage member 4 is not partitioned. A partition wall may be disposed in the course in the depth direction of the flow passage member 4 from the opening 5a, while the part near the opening 5a that opens in the top face of the flow passage member 4 is not partitioned. Also, each of the plural manifolds 5 is formed into a single tube which is completely separated from others. In any case, since presence of an unpartitioned part can reduce the passage resistance and increase the supply amount of the liquid, it is preferred to partition both end parts of the manifold 5 by the partition walls 15.

The plural divided parts of the manifold 5 are also referred to as submanifolds 5b. In the present embodiment, two manifolds 5 each having openings 5a on its both end parts are provided independently. One manifolds 5 is provided with seven partition walls 15, and thus divided into eight submanifolds 5b. The width of the submanifold 5b is larger than the width of the partition wall 15, and this allows a large amount of liquid to pass through the submanifold 5b. The seven partition walls 15 are so designed that the length increases as the position of the partition wall 15 is closer to the center of the width direction, and the end of the partition wall 15 is closer to the end of the manifold 5 as the position of the partition wall 15 is closer to the center of the width direction in both ends of the manifold 5. This structure achieves good balance between the passage resistance generated by the outer wall of the manifold 5 and the passage resistance generated by the partition walls 15, and can reduce the pressure difference of liquid at ends of the region where an individual supply flow passage 14 which leads to the pressurizing chamber 10, in each submanifold 5b. Since the pressure difference in the individual supply flow passage 14 leads to the pressure difference to be applied on the liquid inside the pressurizing chamber 10, the variation in discharge can be decreased by reducing the pressure difference in the individual supply flow passage 14.

The flow passage member 4 is formed by a plurality of pressurizing chambers 10 that are spread two-dimensionally. The pressurizing chamber 10 is a hollow region having a substantially rhombic plane shape having two acute angle parts 10a and two acute angle parts 10b with rounded corners.

The pressurizing chamber 10 connects with one submanifold 5b via the individual supply flow passage 14. Along the one submanifold 5b, a pressurizing chamber array 11, which is an array of pressurizing chambers 10 connecting with the submanifold 5b, is provided on each side of the submanifold 5b, and thus a total of two arrays are provided. Therefore, for one manifold 5, sixteen pressurizing chamber 11 are provided, and thirty two pressurizing chamber arrays 11 are provided in the entire head body 2a. The interval in the longitudinal direction between pressurizing chambers 10 in each pressurizing chamber array 11 is constant, and is, for example, 37.5 dpi.

At ends of the pressurizing chamber array 11, a dummy pressurizing chamber 16 is provided. The dummy pressurizing chamber 16 connects with the manifold 5, but not with the discharge hole 8. Outside the thirty two pressurizing chamber arrays 11, a dummy pressurizing chamber array in which dummy pressurizing chambers 16 are aligned is provided. The dummy pressurizing chamber 16 connects with neither the manifold 5 nor the discharge hole 8. With these dummy pressurizing chambers 16, the structure (rigidity) around the pressurizing chambers 10 in the first inner array from the end becomes similar to the structure (rigidity) of other pressurizing chambers 10, and thus the difference in liquid discharge characteristics can be reduced. Since the influence of the difference in the surrounding structure is greatly influenced by the pressurizing chambers 10 neighboring in the longitudinal direction, which are close to each other, the dummy pressurizing chambers are provided at both ends in the longitudinal direction. As to the width direction, the influence is relatively small, the dummy pressurizing chambers are provided in the margin closer to the end of the head body 21a. This can reduce the width of the head body 21a.

The pressurizing chambers 10 connecting with one manifold 5 are disposed at substantially equal intervals on rows and columns along the row direction which is the longitudinal direction of the liquid discharge head 2 and the column direction which is the lateral direction. The row direction is the same as the direction of the diagonal line connecting the obtuse angle parts 10b of the rhombic pressurizing chamber 10, and the column direction is the same as the direction of the diagonal line connecting the acute angle parts of the rhombic pressurizing chamber 10. In other words, the diagonal lines of the rhombic shape of the pressurizing chamber 10 have no angle with the rows and the columns. By arranging the pressurizing chambers 10 in a grid pattern, and disposing the pressurizing chamber 10 of the rhombic shape having such angles, it is possible to make cross talk small. This is because angular parts are opposed to each other both in the row direction and the column direction for one pressurizing chamber 10, and thus oscillation is less likely to propagate through the flow passage member 4 compared with the case where its sides are opposed to each other. In this case, by making the obtuse angle parts 10b opposed to each other in the longitudinal direction, it is possible to arrange the pressurizing chambers 10 at high density, and thus to arrange the discharge holes 8 at high density in the longitudinal direction, so that it is possible to achieve high resolution of the liquid discharge head 2. While equal intervals can reduce cross talk by avoiding a narrower interval compared with other intervals, intervals of the pressurizing chambers 10 on the rows and on the columns may have a deviation of about ±20%.

When the pressurizing chambers 10 are arranged in a grid pattern, and the piezoelectric actuator substrate 21 is made into a rectangular shape having the periphery along the rows and columns, the individual electrodes 25 formed on the pressurizing chambers 10 are at the same distance from the periphery of the piezoelectric actuator substrate 21, so that the piezoelectric actuator substrate 21 is difficult to be deformed when the individual electrodes 25 are formed. If this deformation is large, a stress can be exerted on the displacement element 30 near the periphery and variation can occur in the displacement characteristics at the time of joining the piezoelectric actuator substrate 21 and the flow passage member 4; however, the variation can be reduced by reducing the deformation. Also, since the dummy pressurizing chamber array of the dummy pressurizing chambers 16 is provided outside the pressurizing chamber array 11 that is closest to the periphery, the influence of the deformation can be less likely to be affected. The pressurizing chambers 10 belonging to the pressurizing chamber array 11 are arranged at equal intervals, and the individual electrodes 25 corresponding to the pressurizing chamber arrays 11 are also arranged at equal intervals. The pressurizing chamber arrays 11 are arranged at equal intervals in the lateral direction, and the arrays of the individual electrodes 25 corresponding to the pressurizing chamber arrays 11 are also arranged at equal intervals in the lateral direction. As a result, it is possible to dispose of the region where influence of cross talk is especially large.

By employing such an arrangement that pressurizing chambers 10 belonging to one pressurizing chamber array 11 do not overlap the pressurizing chambers 10 belonging to the pressurizing chamber array 11 neighboring in the longitudinal direction of the liquid discharge head 2 when the flow passage member 4 is seen two-dimensionally, it is possible to suppress cross talk. On the other hand, when the distance between pressurizing chamber arrays 11 is increased, the width of the liquid discharge head 2 increases, so that the accuracy of installation angle of the liquid discharge head 2 with respect to the printer 1 and the accuracy of the relative positions of the liquid discharge heads 2 in using plural liquid discharge heads 2 influence more greatly on the printing result. The influences of these accuracies on the printing result can be reduced by making the width of the partition wall 15 smaller than the submanifold 5b.

The pressurizing chambers 10 connecting with one submanifold 5b form two pressurizing chamber arrays 11, and the discharge holes 8 connected from the pressurizing chambers 10 belonging to one pressurizing chamber array 11 form one discharge hole array 9. The discharge holes 8 connecting with the pressurizing chambers 10 belonging to two pressurizing chamber arrays 11 respectively open on the opposite sides of the submanifold 5b. In FIG. 5, each partition wall 15 is provided with two discharge hole arrays 9, and the discharge holes 8 belonging to each discharge hole array 9 connect with the submanifold 5b on the side closer to the discharge holes 8 via the pressurizing chambers 10. When they are arranged so that they do not overlap the discharge holes 8 connecting with the neighboring submanifold 5b via the pressurizing chamber array 11 in the longitudinal direction of the liquid discharge head 2, cross talk between flow passages connecting the pressurizing chambers 10 and the discharge holes 8 can be suppressed, and thus cross talk can be further reduced. When all the flow passages connecting the pressurizing chambers 10 and the discharge holes 8 are arranged so that they do not overlap with each other in the longitudinal direction of the liquid discharge head 2, cross talk can be further reduced.

By employing such an arrangement that the pressurizing chambers 10 and the submanifolds 5b are overlapped with each other in a planar view, the width of the liquid discharge head 2 can be reduced. By making the proportion of the overlapping area with respect to the area of the pressurizing chambers 10 more than or equal to 80%, or further more than or equal to 90%, it is possible to further reduce the width of the liquid discharge head 2. The bottom face of the pressurizing chamber 10 in the part where the pressurizing chamber 10 and the submanifold 5b are overlapped with each other has lower rigidity compared with the case where it the pressurizing chamber 10 and the submanifold 5b are not overlapped with each other, and the resultant difference can cause variation in discharge characteristics. By making the proportion of the area of the pressurizing chamber 10 overlapping the submanifold 5b in the entire area of the pressurizing chamber 10 substantially equal among different pressurizing chambers 10, it is possible to reduce the variation in discharge characteristics caused by change in rigidity of the bottom face that forms the pressurizing chamber 10. The phrase “substantially equal” means that the difference in proportion of area falls within 10% or less, particularly 5% or less.

The plural pressurizing chambers 10 connecting with one manifold 5 form a pressurizing chamber group, and there are two pressurizing chamber groups since there are two manifolds 5. The arrangement of pressurizing chambers 10 involved in discharge in each pressurizing chamber group is identical, and these groups are arranged while they are translated in the lateral direction. These pressurizing chambers 10 are arranged in the region facing the piezoelectric actuator substrate 21, on the top face of the flow passage member 4 almost all over the face although there is a part including a slightly larger interval as is the interval between the pressurizing chamber groups. In other words, the pressurizing chamber group formed of these pressurizing chambers 10 occupies the substantially same size and shape as those of the piezoelectric actuator substrate 21. Openings of the pressurizing chambers 10 are closed by the piezoelectric actuator substrate 21 joined to the top face of the flow passage member 4.

From the angular part opposed to the angular part with which the individual supply flow passage 14 of the pressurizing chamber 10 connects, a descender extends that connects to the discharge holes 8 opening in the discharge hole face 4-1 of the bottom face of the flow passage member 4. The descender extends in the direction leaving from the pressurizing chamber 10 in a planar view. More concretely, the descender extends while it leaves in the direction along the longer diagonal line of the pressurizing chamber 10 and deviates right and left with respect to the direction. As a result, the pressurizing chambers 10 can be arranged in a grid having an interval of 37.5 dpi in each pressurizing chamber array 11, and the discharge holes 8 can be arranged at intervals of 1200 dpi as a whole.

In other words, when the discharge holes 8 are projected so that they intersect at right angles with an imaginary line parallel with the longitudinal direction of the flow passage member 4, a total of thirty two discharge holes 8 consisting of sixteen discharge holes 8 connecting with each manifold 5 are situated at equal intervals of 1200 dpi within the range of R of the imaginary line shown in FIG. 5. By supplying the same color of ink to every manifold 5 in this way, it is possible to form an image of a resolution of 1200 dpi as a whole in the longitudinal direction. One discharge hole 8 connecting with one manifold 5 is at an equal interval of 600 dpi within the range of R of the imaginary line. By supplying inks of different colors to the respective manifolds 5 in this way, it is possible to form a two-color image of a resolution of 600 dpi as a whole in the longitudinal direction. In this case, a four-color image of a resolution of 600 dpi can be formed by using two liquid discharge heads 2, and the printing accuracy is increased and setting of printing is facilitated in comparison with the case of using a liquid discharge head capable of printing at 600 dpi.

Further, in the liquid discharge head 2, a reservoir may be joined to the flow passage member 4 so as to stabilize supply of liquid from the opening 5a of the manifold. The reservoir is provided with a flow passage that connects to two openings 5a while branching the liquid supplied from outside, and thus can supply the two openings with the liquid stably. By making the flow passage lengths after branching substantially equal to each other, temperature variation and pressure variation of the liquid supplied from outside are transmitted to the openings 5a of both ends of the manifold 5 with a small time difference, so that it is possible to further reduce the variation in discharge characteristics of liquid droplet in the liquid discharge head 2. By providing the reservoir with a dumper, supply of liquid can be further stabilized. Further, a filter may be provided so as to prevent a foreign matter or the like in the liquid from traveling toward the flow passage member 4. Also, a heater may be provided so as to stabilize the temperature of the liquid traveling toward the flow passage member 4.

At the positions opposed to the pressurizing chambers 10 on the top face of the piezoelectric actuator substrate 21, individual electrodes 25 are formed respectively. Each individual electrode 25 includes an individual electrode body 25a having a size smaller than the pressurizing chamber 10 and a shape almost similar to the pressurizing chamber 10, and an extraction electrode 25b extracted from the individual electrode body 25a. The individual electrodes 25 form an individual electrode array and an individual electrode group likewise the pressurizing chambers 10. The extraction electrode 25b is connected at its one end part with the individual electrode body 25a, and is extracted at its other end part, to the region that passes through the acute angle part of the pressurizing chamber 10 and does not overlap the line extended from the diagonal line connecting the two acute angle parts of the pressurizing chamber 10 outside the pressurizing chamber 10. As a result, it is possible to reduce cross talk. In other end part of the individual electrode 25, a connection land 26 and a connection bump 27 for establishing electric connection with the signal transmission part 92 are formed. More specifically, the individual electrode 25 on the dummy pressurizing chamber 16 is formed with only the connection land 26, and the individual electrode 25 on the pressurizing chamber 10 is formed with the connection land 26 and the connection bump 27. With this structure, pressure is applied to the entire piezoelectric actuator substrate 21 when the piezoelectric actuator substrate 21 and the flow passage substrate 4 are stacked, and the pressure is concentrated in the part of the connection bump 27 when the connection bump 27 and the signal transmission part 92 are connected with each other, and thus excellent connection is achieved.

On the top face of the piezoelectric actuator substrate 21, a common electrode use surface electrode 28 that is electrically connected with the common electrode 24 via a via hole is formed. Two arrays of the common electrode use surface electrodes 28 are formed along the longitudinal direction in the center part of the lateral direction of the piezoelectric actuator substrate 21, and one array of the common electrode use surface electrodes 28 is formed along the lateral direction near a longitudinal end. While the common electrode use surface electrode 28 illustrated in the drawing is formed intermittently on a straight line, it may be formed continuously on a straight line.

As to the piezoelectric actuator substrate 21, it is preferred to form the individual electrodes 25 and the common electrode use surface electrode 28 in one process after laminating the piezoelectric ceramic layer 21a formed with a via hole as will be described later, the common electrode 24, and the piezoelectric ceramic layer 21b, and firing the laminate. The individual electrode 25 is formed after firing because a positional dispersion between the individual electrode 25 and the pressurizing chamber 10 greatly influences on the discharge characteristics, and a distortion can occur in the piezoelectric actuator substrate 21 if firing is conducted after formation of the individual electrode 25, and if the piezoelectric actuator substrate 21 with a distortion is joined with the flow passage member 4, the piezoelectric actuator substrate 21 is in a stressed condition so that variation in displacement can arise. The individual electrode 25 and the common electrode use surface electrode 28 are formed in the same process because a distortion can occur also in the common electrode use surface electrode 28, and simultaneous formation with the individual electrode 25 can increase the positional accuracy and simplify the process.

Since the positional variation of via hole due shrinkage by firing that can be caused at the time of firing the piezoelectric actuator substrate 21 occurs mainly in the longitudinal direction of the piezoelectric actuator substrate 21, the common electrode use surface electrode 28 is disposed in the center of an even number of manifolds 5, or in other words, in the center of the lateral direction of the piezoelectric actuator substrate 21, and the common electrode use surface electrode 28 has a shape that is long in the longitudinal direction of the piezoelectric actuator substrate 21. This can prevent the via hole and the common electrode use surface electrode 28 from being out of electrical connection due to the positional deviation.

On the piezoelectric actuator substrate 21, two signal transmission parts 92 are disposed and joined so that they are directed from two long-side sides of the piezoelectric actuator substrate 21 to the center. At this time, by forming and connecting the connection bump 27 and the connection bump for common electrode, respectively, on the connection land 26 on the extraction electrode 25b of the piezoelectric actuator substrate 21a, and on the common electrode use surface electrode 28, it is possible to facilitate the connection. Also, at this time, by making the area of the common electrode use surface electrode 28 and the connection bump for common electrode larger than the area of the connection bump 27, it is possible to reinforce the connection in end part (tip end and longitudinal end of the piezoelectric actuator substrate 21) of the signal transmission part 92 by the connection on the common electrode use surface electrode 28, and thus to make the signal transmission part 92 less likely to be detached from the ends.

The discharge holes 8 are disposed in positions other than the region opposed to the manifold 5 arranged on the bottom face side of the flow passage member 4. Further, the discharge holes 8 are arranged in the region opposed to the piezoelectric actuator substrate 21 on the bottom face side of the flow passage member 4. These discharge holes 8, as one group, occupy the region having substantially the same size and shape with the piezoelectric actuator substrate 21, and each discharge hole 8 can discharge a liquid droplet by displacement of the corresponding displacement element 30 of the piezoelectric actuator substrate 21.

The flow passage member 4 contained in the head body 2a has a laminated structure including a plurality of plates. These plates include, in sequence from the top face of the flow passage member 4, a cavity plate 4a, a base plate 4b, an aperture plate 4c, a supply plate 4d, manifold plates 4e to 4j, a cover plate 4k and a nozzle plate 4l. These plates are formed with a large number of holes. Since each plate has a thickness ranging from about 10 to 300 μm, it is possible to improve the formation accuracy of the formed holes. These plates are laminated while they are registered so that these holes communicate with each other to form an individual flow passage 12 and the manifold 5. The head body 2a includes the parts constituting the individual flow passage 12 disposed at adjacent different positions: the pressurizing chamber 10 disposed on the top face of the flow passage member 4, the manifold 5 disposed on the bottom face side of the interior, and the discharge holes 8 disposed on the bottom face, and thus has such a structure that the manifold 5 connects with the discharge holes 8 via the pressurizing chamber 10.

The holes formed in respective plates will be described. These holes include the following. The first hole is the pressurizing chamber 10 formed in the cavity plate 4a. The second hole is the communication hole constituting the individual supply flow passage 14 that connects from one end of the pressurizing chamber 10 to the manifold 5. This communication hole is formed in each plate from the base plate 4b (specifically, inlet of the pressurizing chamber 10) to the supply plate 4c (specifically, outlet of the manifold 5). This individual supply flow passage 14 includes an aperture 6 which is the site where the section area of the flow passage is reduced, formed in the aperture plate 4c.

The third hole is a communication hole that constitutes the flow passage communicating from the other end of the pressurizing chamber 10 to the discharge holes 8, and this communication hole is referred to as a descender hereinafter (partial flow passage). The descender is formed in each plate from the base plate 4b (specifically, outlet of the pressurizing chamber 10) to the nozzle plate 4l(specifically, discharge hole 8). The hole of the nozzle plate 4l has a diameter of, e.g., 10 to 40 μm, as the discharge hole 8 opening outside the flow passage member 4, which gradually increases inwardly. The fourth hole is a communication hole constituting the manifold 5. This communication hole is formed in the manifold plates 4e to 4j. The manifold plates 4e to 4j are formed with holes so that partition parts which are to become the partition walls 15 for constituting the submanifold 5b are left. The partition parts in the manifold plates 4e to 4j are brought into connection with the periphery of the respective manifold plates 4e to 4j through half-etched tabs because the structure would be no longer retained if the entire part that is to become the manifold 5 is made into a hole.

The first to fourth communication holes are mutually connected to form the individual flow passage 12 that extends from the flow inlet of liquid from the manifold 5 (outlet of the manifold 5) to the discharge hole 8. The liquid supplied to the manifold 5 is discharged from the discharge hole 8 in the following route. First, the liquid travels upward from the manifold 5, and enters the individual supply flow passage 14, and reaches one end part of the aperture 6. Then the liquid travels horizontally along the extending direction of the aperture 6, and reaches the other end part of the aperture 6. The liquid travels upward from there, and reaches one end part of the pressurizing chamber 10. Further, the liquid travels horizontally along the extending direction of the pressurizing chamber 10, and reaches the other end part of the pressurizing chamber 10. The liquid travels principally downward while it moves little by little in the horizontal direction from there, and travels to the discharge hole 8 opening on the bottom face.

The piezoelectric actuator substrate 21 has a laminated structure including two piezoelectric ceramic layers 21a, 21b which are piezoelectric bodies. Each of these piezoelectric ceramic layers 21a, 21b has a thickness of about 20 μm. The thickness from the bottom face of the piezoelectric ceramic layer 21a to the top face of the piezoelectric ceramic layer 21b in the piezoelectric actuator substrate 21 is about 40 μm. Any layer of the piezoelectric ceramic layers 21a, 21b extends to span a plurality of pressurizing chambers 10. These piezoelectric ceramic layers 21a, 21b are formed of, for example, a lead zirconate titanate (PZT)-based ceramic material having ferroelectricity.

The piezoelectric actuator substrate 21 has the common electrode 24 formed of a metal material of Ag—Pd system or the like, and the individual electrode 25 formed of a metal material of Au system or the like, and these are formed, for example, by firing. As described above, the individual electrode 25 includes the individual electrode body 25a disposed at the position opposed to the pressurizing chamber 10 on the top face of the piezoelectric actuator substrate 21, and the extraction electrode 25b extracted therefrom. In the part extracted outside the region opposed to the pressurizing chamber 10, in one end of the extraction electrode 25b, the connection land 26 is formed. The connection land 26 is formed of a metal material of Ag—Pd system, and is formed, for example, by firing. On the connection land 26 that is required to conduct electricity, the connection bump 27 is disposed. The connection land 26 is formed, for example, by printing an Ag paste prepared by mixing resin and Ag powder, followed by heating and drying. The connection land 26 is 50 to 300 μm in diameter, and 1 to 10 μm in height. The connection bump 27 is 50 to 300 μm in diameter, and 10 to 100 μm in height, and is formed to have a convex cross section shape. The connection land 26 is electrically joined with a wiring 92c provided in the signal transmission part 92. Only the connection bump 27 may be formed as a connection electrode while the connection land 26 is not formed. In FIG. 6, since the connection land 26 and the connection bump 27 are connected with the wiring 92c in a deeper position than the illustrated cross section, the connection bump 26 and the wiring 92c are not connected in the illustrated cross section. The shape and arrangement of the connection land 26 will be later described in detail later. The individual electrode 25 is provided with a driving signal from the control section 100 through the signal transmission part 92. The driving signal is supplied with a constant periodicity in synchronization with the transport speed of printing medium P.

The common electrode 24 is formed almost all over the face in the planar direction in the region between the piezoelectric ceramic layer 21a and the piezoelectric ceramic layer 21b. In other words, the common electrode 24 extends in such a manner that it covers every pressurizing chamber 10 in the region opposed to the piezoelectric actuator substrate 21. The thickness of the common electrode 24 is about 2 μm. The common electrode 24 is connected with the common electrode use surface electrode 28 that is formed in the position keeping away from the electrode group including the individual electrodes 25 on the piezoelectric ceramic layer 21b, via a via hole formed in the piezoelectric ceramic layer 21b, and grounded to keep the ground potential. Likewise the large number of plural individual electrodes 25, the common electrode use surface electrode 28 is connected with another wiring 92c on the signal transmission part 92.

As will be described later, as a result of selective supply of a predetermined driving signal to the individual electrode 25, the volume of the pressurizing chamber 10 corresponding to the individual electrode 25 changes, and pressure is applied on the liquid in the pressurizing chamber 10. As a result, a liquid droplet is discharged from the corresponding liquid discharge hole 8 through the individual flow passage 12. In other words, the part opposed to each pressurizing chamber 10 in the piezoelectric actuator substrate 21 corresponds to the individual displacement element 30 corresponding to each pressurizing chamber 10 and liquid discharge hole 8. In other words, in the laminated body including the two piezoelectric ceramic layers 21a, 21b, the displacement element 30 which is a piezoelectric actuator having the structure as shown in FIG. 6 as a unit structure is built in for each pressurizing chamber 10, by a diaphragm 21a, the common electrode 24, the piezoelectric ceramic layer 21b, and the individual electrode 25 positioned right above the pressurizing chamber 10. Thus, the piezoelectric actuator substrate 21 contains a plurality of displacement elements 30 which are pressuring parts. In the present embodiment, the amount of liquid discharged from the liquid discharge hole 8 by one discharge operation is about 1.5 to 4.5 μl (pico litter).

Each of the large number of individual electrodes 25 is electrically connected with the control section 100 individually through the signal transmission part 92 and wiring for enabling individual control of the potential. When an electric field is applied on the piezoelectric ceramic layer 21b in its polarization direction by making the individual electrode 25 have a potential different from that of the common electrode 24, the part to which the electric field is applied functions as an active part that is distorted by the piezoelectric effect. In this configuration, when the individual electrode 25 is made to have a positive or negative predetermined potential, relative to the common electrode 24 by the control section 100 in order to align the directions of the electric field and the polarization, the part sandwiched by the electrodes of the piezoelectric ceramic layer 21b (active part) shrinks in the planar direction. On the other hand, since the piezoelectric ceramic layer 21a, which is an inactive layer, is not influenced by the electric field, it does not shrink voluntarily and tends to regulate deformation in the active part. As a result, difference in distortion occurs in the polarization direction between the piezoelectric ceramic layer 21b and the piezoelectric ceramic layer 21a, and the piezoelectric ceramic layer 21b deforms to be concave toward the pressurizing chamber 10 (unimorph deformation).

The actual driving procedure in the present embodiment is as follows. The individual electrode 25 is set at a higher potential than the common electrode 24 (hereinafter, referred to as high potential) in advance, and the individual electrode 25 is temporarily brought to the same potential (hereinafter, referred to as low potential) as the common electrode 24 whenever a discharge request is issued, and then brought to the high potential again in a predetermined timing. As a result, the piezoelectric ceramic layers 21a, 21b recovers their original shapes at the timing that the individual electrode 25 is brought to the low potential, and the capacity of the pressurizing chamber 10 increases in comparison with that in the initial state (the state that the electrodes have different potentials). At this time, a negative pressure is applied inside the pressurizing chamber 10, and the liquid is sucked into the pressurizing chamber 10 from the side of the manifold 5. Then at the timing that the individual electrodes 25 is again brought to the high potential, the piezoelectric ceramic layers 21a, 21b deform to be concave toward the pressurizing chamber 10, and the reduction in capacity of the pressurizing chamber 10 makes the internal pressure of the pressurizing chamber 10 positive to increase the pressure on the liquid, and thus a liquid droplet is discharged. In other words, a driving signal containing pluses based on the high potential is supplied to the individual electrode 25 for discharging a liquid droplet. This pulse width is ideally AL (Acoustic Length, time length required for transmission of the pressure wave from the aperture 6 to the discharge hole 8) that is a half of the volume variation period of the liquid in the liquid pressurizing chamber and in the flow passage from the liquid pressurizing chamber to the liquid discharge hole. With this configuration, the pressures of these come together at the time when the interior of the pressurizing chamber 10 turns into the positive pressure condition from the negative pressure condition, so that the liquid droplet can be discharged at higher pressure.

In gradation printing, gradation is expressed by the number of liquid droplets discharged continuously from the discharge hole 8, namely by the amount (volume) of liquid droplets adjusted by the number of liquid droplet discharges. For this reason, the number of times of liquid droplet discharges corresponding to the specified graduation expression are continuously conducted from the discharge hole 8 corresponding to the specified dot region. In general, when liquid discharge is conducted continuously, it is preferred to set the interval between pulses supplied for dishcharge of a liquid droplet at AL. As a result, the period of residual pressure wave of the pressure occurring at the time of discharging the previously discharged liquid droplet coincides with the period of pressure wave of the pressure occurring at the time of discharging the later discharged liquid droplet, so that these pressure waves are superimposed and the pressure at the time of discharging a liquid droplet can be further amplified. In this case, it is expected that the later the liquid droplet is discharged, the higher the speed of the liquid droplet is, and this is desirable because the points of impact of the plural liquid droplets are closer to each other.

Here, the shape and arrangement of the connection electrode will be described in detail. As the connection electrode, the connection land 26 may be formed (the connection bump 27 is further formed for electrical connection with the signal transmission part 92), or only the connection bump 27 may be formed while the connection land 26 is omitted as is in the above embodiment. In any case, by forming the connection electrode, the piezoelectric actuator substrate 21 directly above the pressurizing chamber 10 becomes less likely to be broken during lamination. Forming only the connection bump 27 while omitting the connection land 26 is preferred because the process can be simplified by joining the plates 4a to 4m and the piezoelectric actuator substrate 21 by conducting lamination and pressurization after applying an adhesive between these. In the following, description will be made for the case where the connection land 26 is formed as the connection electrode, and the arrangement or the like also applies to the case where only the connection bump 27 is formed.

In lamination with the flow passage member 4, the connection lands 26 include those disposed on the manifold 5, and those disposed in the region other than the manifold 5. In such a case, the piezoelectric actuator substrate 21 located on the manifold 5, and the plates 4a to 4d existing between the manifold 5 and the piezoelectric actuator substrate 21 bend toward the manifold 5 upon application of pressure, and thus are weakened accordingly, and the pressure applied on respective interlayers of the piezoelectric actuator substrate 21 and the plates 4a to 4d is weaker than that in the partition walls 15 or the peripheral part of the flow passage member 4, so that adhesion can be insufficient. With insufficient joining, the liquid enters peripheral interlayers from the flow passage to change the flow passage characteristics, and this may cause variation in the liquid discharge characteristics, or mixing of the liquid when different liquids flow in the neighboring flow passages.

By making the number of the connection lands 26 per unit area disposed in a first region D1 not overlapping the manifold 5 greater than the number of the connection lands 26 per unit area disposed in a first region D2 overlapping the manifold 5, strong pressure is applied on the partition wall 15 and the peripheral part of the flow passage member 4 to compress such a part, and allows application of the pressure even when the piezoelectric actuator substrate 21 and the plates 4a to 4d on the manifold 5 bend. With this measure, joining on the manifold 5 is also satisfactory. This is particularly effective for the case where the total thickness of the piezoelectric actuator substrate 21 and the plates 4a to 4d on the manifold 5 is as small as 500 μm less, or further 300 μm or less because the bending is large with such a small thickness. This is especially effective when there are plural plates on the manifold 5, or in other words, when not only joining between the piezoelectric actuator substrate 21 and the plates on the manifold 5, but also joining between the plates on the manifold 5 are required.

Here, the number per unit area can be calculated in a region D where the pressurizing chambers 10 form a group of mass, rather than in the entire piezoelectric actuator substrate 21. The phrase “form a group of mass” concretely means the mass of the pressurizing chambers 10 on the upper side forms one group, and the mass of the pressurizing chambers 10 on the lower side forms another group in FIG. 3. The term “a group of mass” used herein means an assembly of pressurizing chambers 10 that are regularly disposed, and means the largest one of such assemblies. The region D involves every pressurizing chamber 10 in the one group as described above, and the profile of the region D is defined as being in contact with the outermost pressurizing chamber 10. Use of such a region for calculation comes from the fact that if such a part that does not particularly involve a discharge function or the like, for example the part where no displacement element 30 is present, or the part where the manifold 5 or the like is not present directly below as in end parts of the piezoelectric actuator substrate 21 is taken into account in the calculation, the result would be deviated from the essential numerical value. When the connection land 26 is disposed on the boundary between the first region D1 and the second region D2, the calculation may be made separately for the areas belonging to the respective regions. For example, when 70% of the area of one connection land 26 spans the first region D1 and the remaining 30% spans the second region D2, the calculation may be made on the assumption that 0.7 connection lands 26 are present in the first region D1 and 0.3 connection lands 26 are present in the second region D2.

Further, when the area of the connection land 26 largely differs depending on the site, the value obtained by dividing the total area of the connection land 26 by the area of the region may be compared. Also in that case, for the connection land 26 disposed on the boundary, calculation may be made separately for the areas belonging to the respective regions.

While one connection land 26 is provided for each individual electrode 25 in the drawing, two or more may be provided. The proportion of disposition may be varied by changing the number of connection lands 26 provided for one individual electrode 25.

In the present embodiment, the density is 2.92/mm² in the first region D1, and 1.05/mm² in the second region D2. By setting the density of disposition in the first region D1 with respect to that in the second region D2 at 1.5 times or more, further 2 times or more, in particular 2.5 times or more, it is possible to push the partition wall 15 or the like more strongly and more excellent joining on the manifold 5 is achieved. On the other hand, it is preferably 10 times or less because when the density of disposition in the first region D1 is extremely high compared with the second region D2, the force of pushing on the manifold 5 can be insufficient.

In the above, the partition wall 15 or the like is strongly pushed by disposition of the connection land 26, however, the partition wall 15 or the like may be pushed strongly by the dummy connection land 36. The dummy connection land 36 is a dummy to which a driving signal for driving the displacement element 30 is never supplied. Basically, the dummy connection land 36 is in the condition of not being electrically connected with the individual electrode 25. Inversely, the dummy connection land 36 may be in the condition of not being electrically connected with the wiring 92c of the signal transmission part 92. Desirably, the dummy connection land 36 is in the condition of not being electrically connected with both the individual electrodes 25 and the wiring 92c. Since the dummy connection land 36 is not used for conduction of electricity, the material, the dimension and the like can be selected relatively freely. However, by forming the dummy connection land 36 using the same material as the connection land 26, and forming the dummy connection land 36 simultaneously with the connection land 26, the process can be simplified. Basically, the connection land 26 and the dummy connection land 36 are substantially the same in height, e.g., within ±30% for allowing transmission of pressure through the connection land 26 and the dummy connection land 36. The heights may be different for adjusting the pressure. Preferably, they have substantially the same area, e.g., within ±30% for relatively uniform application of pressures between different regions. Different areas may be employed for adjusting the pressure.

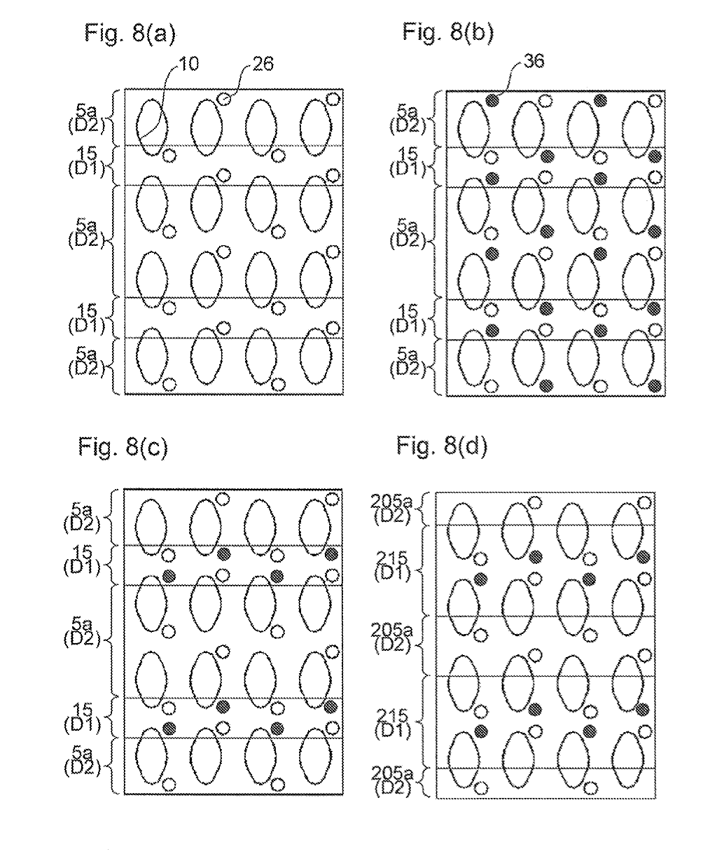

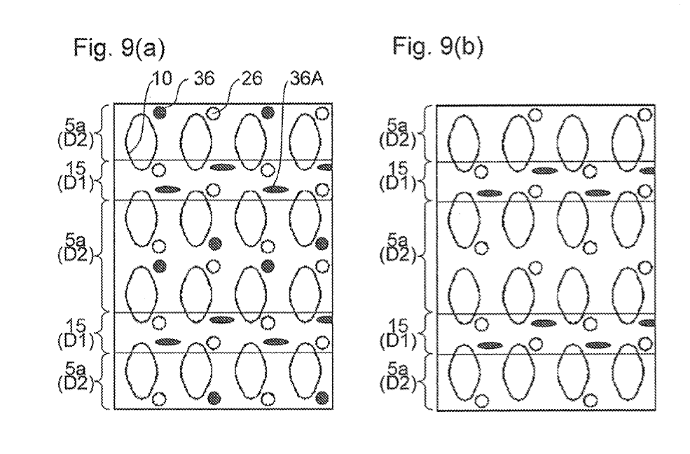

FIGS. 8(a) to (d), and FIGS. 9(a) (b) are schematic views illustrating the arrangements of the pressurizing chambers 10, the submanifolds 5a, 205a (manifold), the partition walls 15, 215, the connection lands 26 and the dummy connection lands 36, 36A. FIG. 8 (a) illustrates the same arrangement as shown in FIGS. 2 to 7. While individual electrodes 25 are not illustrated in the drawing, the connection land 26 is connected with the individual electrode 25 overlapping the nearest pressurizing chamber 10, and the dummy connection lands 36, 36A are not electrically connected with individual electrodes 25, and are not configured to drive the displacement element 30. The dummy connection land 36 may be formed directly on the piezoelectric ceramic layer 21b, or may be formed on a dummy electrode formed in the same manner as the individual electrode 25 for making the height closer to that of the connection land 26. On the dummy connection land 36, the dummy connection bump 27 is not necessarily formed, but the dummy connection bump 27 may be formed. By connecting the dummy connection bump 27 and the signal transmission part 92, it is possible to reinforce the connection with the signal transmission part 92.

In FIGS. 8(a) to (c), the arrangements of submanifolds 5a and partition walls 15 are identical, and the submanifold 205a in FIG. 8(d) has a smaller width than the submanifold 5a in FIGS. 8(a) to (c), and the partition wall 215 in FIG. 8 (d) has a larger width than the partition wall 15 in FIGS. 8(a) to (c).

In FIG. 8(b), the dummy connection land 36 is disposed in the same proportion as the connection land 26, in the first region D1 and the second region D2, respectively. In other words, the ratio of disposition of the dummy connection land 36 in the first region D1 to the second region D2 is high, and thus the partition wall 15 or the like can be strongly pushed. A desired ratio of disposition between the first region D1 and the second region D2 is equivalent to that in the case of the connection land 26. In this case, the proportion of disposition of combination of the connection land 26 and the dummy connection land 36 is higher in the first region D1 than in the second region D2, and thus the partition wall 15 or the like can be strongly pushed.

In FIG. 8(c), the dummy connection land 36 is disposed only in the first region D1. Since the connection land 26 has a function of supplying the displacement element 30 with a voltage for driving, a restriction in design arises. For example, if the shapes of the extraction electrode 25b are largely different among the displacement elements 30, the resistance and the capacity can vary, and the influence exerted by piezoelectric driving of the piezoelectric ceramic layer 21b beneath the extraction electrode 25b can vary. Therefore, the shapes of the extraction electrodes 25b are made to be identical to some extent. Also, the extraction electrode 25b is made relatively short, and the connection land 26 is disposed near the individual electrode body 25 (nearer than the neighboring individual electrode body 25) so as to reduce cross talk and prevent occurrence of a short circuit. In contrast to this, since the dummy connection electrode 36 can be disposed relatively freely, it can be disposed only in the first region D1 to push the partition wall 15 or the like more strongly.

In FIG. 8(d), since the width of the partition wall 215 is large, the proportion of disposition is smaller in the first region D1 than in the second region D2 even when the connection land 26 is disposed evenly. In this case, by disposing the dummy connection land 36 so that the proportion of disposition is larger in the first region D1 than in the second region D2, it is possible to improve such a disadvantageous situation. As a result, in FIG. 8(d), the proportion of disposition of combination of the connection land 26 and the dummy connection land 36 is higher in the first region D1 than in the second region D2.

FIGS. 9(a)(b) are similar to FIG. 8(b) and FIG. 8(c) in the arrangement of dummy connection electrodes; however, the dummy connection land 36A disposed in the second region D2 extends along the boundary between the first region D1 and the second region D2. With such a shape, the difference in pressure exerted on the partition wall 15 in longitudinal direction of the manifold 5 is small, and pressure can be applied to the partition wall 15 more securely.

By setting the area of the connection land 26 disposed in the second region D2 overlapping the manifold 5 larger than the area of the connection land 26 disposed in the first region D1 overlapping a region other than the manifold 5, pressure is exerted strongly on the partition wall 15 or the peripheral part of the flow passage member 4 to compress the parts. As a result, pressure is applied even when the piezoelectric actuator substrate 21 and the plates 4a to 4d on the manifold 5 bend. This achieves excellent joining also on the manifold 5. The area is preferably made larger by 5% or more, preferably 10% or more, and especially 20% or more. When there is a connection land 26 located on the lateral wall of the manifold 5, discrimination may be made depending on whether the areal center of gravity of the shape of the connection land 26 is on the fold 5 or not.

Also, by making the height of the connection land 26 disposed in the second region D2 overlapping the manifold 5 higher than the height of the connection land 26 disposed in the first region D1 overlapping a region other than the manifold 5, pressure is exerted strongly on the partition wall 15 or the peripheral part of the flow passage member 4 to compress the parts. As a result, pressure is applied even when the plates 4a to 4d on the manifold 5 bend. This achieves excellent joining also on the manifold 5. The area is preferably made larger by 5% or more, and preferably 10% or more. More preferably, both the area and the height are varied.

The area and the height may be adjusted with the connection land 26 as described above, or with the dummy connection land 36.

Further, by making the height of the connection land 26 disposed in the second region D2 overlapping the manifold 5 higher than the rigidity of the connection land 26 disposed in the first region D1 overlapping a region other than the manifold 5, pressure is exerted strongly on the partition wall 15 or the peripheral part of the flow passage member 4 to compress the parts. In this manner, pressure can be applied even when the plates 4a to 4d on the manifold 5 bend.

In the aforementioned state, a plurality of connection electrodes (connection land 26 or connection bump 27) are disposed on one principal plane of the piezoelectric actuator substrate 21 in the case of the single piezoelectric actuator substrate 21, and the one principal plane is separated into the first region D1 not overlapping the manifold 5 and the second region D2 overlapping the same when it is made into liquid discharge head 2, and the number of connection electrodes per unit area disposed in the first region D1 is greater than the number of connection electrodes per unit area disposed in the second region D2.

The shape of the first region D1 is identical to the shape of the region of the manifold 5, and the shape of the second region D2 is identical to the shape of the region other than the manifold 5. In FIG. 4, since the line indicating the shape of the manifold 5 and the lines indicating the first region D1 and the second region D2 are overlapped with each other, D1 is indicated to surround the assembly of the connection lands 26 disposed in the first region D1, and D2 is indicated to surround the assembly of the connection lands 26 disposed in the second region D2. In the present embodiment, pressurization in the piezoelectric actuator substrate 21 is uniformed by providing the connection land 26 also in the dummy pressurizing chamber 16.

A dummy electrode land which is a dummy connection electrode may be provided besides the connection land 26 corresponding to the aforementioned dummy pressurizing chamber 16. By disposing the dummy electrode land in the region other than the manifold 5, it is possible to apply pressure more strongly on the partition wall 15 or the peripheral part of the flow passage member 4, and joining on the manifold 5 is further improved.

Further, even if joining itself is sufficient, when the piezoelectric actuator substrate 21 and the plates 4a to 4d are joined while they are bent toward the manifold 5 due to pressure, the bending remains even after the pressure during lamination has gone away. This may cause variation in discharge characteristics. So, by disposing the connection land 26 disposed in the second region D2 at a position near the lateral wall of the manifold 5, it is possible to reduce the bending at the time of joining, and hence the bending remaining after joining, and to reduce the influence thereof. Concretely, by disposing the connection land 26 at a position closer to the lateral wall from the center of the width direction of the submanifold 5b (more specifically, disposing in quarter region closest to one lateral wall, or in a quarter region closest to the other lateral wall of the submanifold 5b quartered in the width direction), it is possible to reduce the bending during joining of the piezoelectric actuator substrate 21 and the plates 4a to 4d on the manifold 5.

Further, the connection land 26 or the dummy connection land 36 which is a dummy connection electrode disposed in the first region D1 is preferably disposed at a substantial distance from the partition wall 15 because part of the force pushing the partition wall 15 will escape if the connection land 26 or the dummy connection land 36 is disposed at the position near the lateral wall of the submanifold 5a. Concretely, when the distance from the top face of the piezoelectric actuator substrate 21 to the submanifold 5a is represented by h [mm], the distance from the lateral wall of the submanifold 5a to the end of the connection land 26 or the dummy connection land 36 located at the closest position to the lateral wall of the submanifold 5a is desirably set at more than or equal to h [mm] because the force is more likely to escape as this depth increases. In the aforementioned embodiment, h=0.18 mm.

While the pressure of joining may be increased by increasing the bending by employing greater height of the connection land 26 disposed in the first region D1, actually the height or the area of the connection land 26 disposed in the second region D2 is increased in consideration of influence of joining associated accompanied by bending as described above.

Here the shapes and arrangements of the connection land 26 and the extraction electrode 25b connecting the connection land 26 and the individual electrode body 25a will be described. For simplifying the structure of the displacement element 30 or the production process of the piezoelectric actuator substrate 21, the piezoelectric ceramic layer 21b beneath the extraction electrode 25b is polarized, and the piezoelectric ceramic layer 21 beneath the extraction electrode 25b is also piezoelectricelectrically deformed upon application of the voltage on the individual electrode body 25a.

Piezoelectricelectric deformation of the piezoelectric ceramic layer 21 beneath the extraction electrode 25b in the pressurizing chamber 10 influences on the displacement of the displacement element 30. For example, when the piezoelectric ceramic layer 21b beneath the individual electrode body 25a is shrunk in the planar direction and the displacement element 30 is bent and deformed toward the pressurizing chamber 10, the piezoelectric ceramic layer 21 beneath the extraction electrode 25b inside the pressurizing chamber 10 also shrinks in the planar direction, and the displacement decreases. By extracting the extraction electrode 25b from the acute angle part of the pressurizing chamber 10b, it is possible to reduce the decrease in the displacement amount. Since the deformation occurs in the vicinity of the acute angle part when the piezoelectric ceramic layer 21b beneath the individual electrode body 25a deforms in the planar direction, the displacement of the displacement element 30 is small even when the same deforming force arises, and thus the decrease in displacement which is the result of combining the displacement in the direction in which the displacement element 30 is originally intended to be deformed is small. On the contrary, when the extraction electrode 25b is extracted in the midway of the side of the rhombic shape of the pressurizing chamber 10, the displacement is large because deformation at that part is likely to displace the displacement element 30, therefore, the decrease in displacement which is the result of combining the displacement in the direction in which the displacement element 30 is originally intended to be deformed is large. For example, in the displacement element 30 having the planar shape shown in FIG. 4, the displacement decreases by about 1% when the extraction electrode 25b is extracted from the midway of the side, in comparison with the case where the extraction electrode 25b is extracted from the acute angle part.

Since the piezoelectric ceramic layer 21 beneath the extraction electrode 25b extracted outside the pressurizing chamber 10 also piezoelectricelectrically deforms, the displacement of the neighboring displacement element 30 is also influenced. This influence comes in part from transmission of vibration, and in part from transmission of stress to the piezoelectric ceramic layer 21b of the neighboring displacement element 30 when the piezoelectric ceramic layer 21b beneath the extraction electrode 25b expand or contract in the planar direction due to the shape of the piezoelectric ceramic layer 21b covering the plural pressurizing chambers 10. Reduction in cross talk as will be described below is particularly useful in the piezoelectric actuator substrate 21 in which the piezoelectric ceramic layers 21b are connected between the neighboring displacement elements 30.

Next, the shape of the individual electrode 25 will be described by referring to the individual electrode 25 in the center lower side of FIG. 7. The extraction electrode 25b extracted from the acute angle part side of the individual electrode 25 needs to be extracted to the position at a substantial distance from the pressurizing chamber 10 for securing the part which is to be a terminal having a certain area for connection with outside. In this case, by preventing the other end part of the extraction electrode 25b on the opposite side of the one end part connected with the individual electrode body 25a from overlapping the line extended from the diagonal line connecting the acute angle parts (imaginary line LB1), it is possible to increase the distance from the displacement element 30 neighboring on the acute angle part side, and thus to reduce cross talk. For achieving this, the extraction electrode 25b is extracted in such a manner than the extraction electrode 25b is bent toward the row direction from the column direction in which the extraction electrode 25b is directed when the extraction electrode 25b is extracted from the acute angle part. In FIG. 7, the extraction electrode 25b is extracted in such a manner that the extraction electrode 25b is bent about 90 degrees into the row direction; however, the bending angle may be larger than 90 degrees or smaller than 90 degrees. When the bending angle is large, the distance to the neighboring pressurizing chamber 10 increases, so that it is possible to reduce cross talk, and to dispose the connection land 26 at a position closer to the lateral wall than the center of the submanifold 5b.

In particular, by disposing the extraction electrode 25b on the imaginary line LA1 which passes through the one acute angle part of the pressurizing chamber 10 from which the extraction electrode 25b is extracted, and is parallel with the diagonal line connecting the obtuse angle parts 10b of the pressurizing chamber 10, or on the pressurizing chamber 10 side from the imaginary line LA1, the distance between the extraction electrode 25b and the pressurizing chamber 10 that is neighboring on the acute angle part side can be increased, and thus cross talk can be reduced. More specifically, when the distance from the pressurizing chambers 10 neighboring on the acute angle part side is compared, the entire extraction electrode 25b farther from the pressurizing chamber 10 neighboring on the acute angle part side than the part of an S shape closest to the pressurizing chamber 10 neighboring on the acute angle part side when the shape S (circular in this case) which is the same with the other end part (the tip end of the extracted extraction electrode 25b, usually serving as a terminal) of the extraction electrode 25b is disposed at the tip of the acute angle part, and thus cross talk can be reduced. This means that cross talk can be reduced by bringing the extraction electrode 25b into the condition that the extraction electrode 25b is at a larger distance from the pressurizing chamber 10 neighboring on the acute angle part side (disposed on the side closer to the pressurizing chamber 10 from which it is extracted, than LA2), compared with the case where a terminal is provided very near the acute angle part of the pressurizing chamber 10.

Since the extraction electrode 25b is formed in the region closer to the pressurizing chamber 10 from which the extraction electrode 25b is extracted, than the pressurizing chamber 10 neighboring on the obtuse angle part 10b side of the pressurizing chamber 10 from which the extraction electrode 25b is extracted, it is possible to reduce cross talk with the displacement element 30 neighboring on the obtuse angle part 10b side. To be more specific, considering the imaginary line LB2, which passes the obtuse angle part 10b of the pressurizing chamber 10 from which the extraction electrode 25b is extracted, and is parallel with the diagonal line connecting the acute angle parts, and the imaginary line LB3, which is parallel with the imaginary line LB2, and passes the obtuse angle part 10b of the neighboring pressurizing chamber 10 opposed to the obtuse angle part 10b, the extraction electrode 25b is disposed in the region closer to the pressurizing chamber 10 from which the extraction electrode 25b is extracted, than the imaginary line LB4 which is in the middle of these imaginary lines.

The shape of the piezoelectric actuator substrate of the present invention is not limited to the above embodiments as far as plural connection electrodes (connection land 26 or connection bump 27) are formed on one principal plane, and for example, there are a plurality of polarized piezoelectric ceramic layers, and a displacement element may be formed by arranging a common electrode and an individual electrode alternately.

The above-described liquid discharge head 2 is manufactured, for example, in the following manner. A tape composed of piezoelectricelectric ceramic powder and an organic composition is formed by a common tape forming method such as roll coater method or slit coater method, and a plurality of green sheets which are to become the piezoelectric ceramic layers 21a, 21b after firing the tape are prepared. On the surface in a part of the green sheet, an electrode paste which is to become the common electrode 24 is formed by a printing method or the like. A via hole is formed in a part of the green sheet as needed, and the interior of the via hole is filled with a via conductor.

Then the green sheets are laminated to prepare a laminated body, and adhered to each other by pressurization, and the resultant laminate is cut into a rectangular shape, and fired in an atmosphere of high concentration oxygen. On the surface of the piezoelectric actuator element assembly after firing, an organic metal paste is printed by screen printing, and fired to form the individual electrodes 25. Thereafter, an Ag—Pd paste is printed, and fired to form the connection land 26 and the common electrode use surface electrode 28. At this time, the number of the connection land 26 per unit area disposed in the first region D1 is set greater than the number of the connection land 26 per unit area disposed in the second region D2.

Then the flow passage member 4 is prepared by laminating the plates 4a to 4l obtained by a rolling method or the like via an adhesive layer. In the plates 4a to 4l, holes that are to become the manifold 5, the individual supply flow passage 14, the pressurizing chamber 10, the descender and the like are worked into predetermined shapes by etching.

Preferably, these plates 4a to 4l are formed of at least one metal selected from the group consisting of Fe—Cr system, Fe—Ni system, and WC-TiC system, and in particular, when ink is used as the liquid, Fe—Cr system is more preferred because it is desired that the plates are formed of the material having excellent corrosion resistance to the ink.

The piezoelectric actuator substrate 21 and the flow passage member 4 can be laminated and adhered, for example, via an adhesive layer. As the adhesive layer, a well known adhesive may be used, however, it is desired to use an adhesive based on at least one thermosetting resin selected from the group consisting of epoxy resin, phenol resin and polyphenylene ether resin having a thermosetting temperature of 100 to 150° C. for preventing influence on the piezoelectric actuator substrate 21 and the flow passage member 4. By heating such an adhesive layer to the thermosetting temperature, it is possible to heat-joining the piezoelectric actuator substrate 21 and the flow passage member 4 together. After joining, voltage is applied between the common electrode 24 and the individual electrode 25 of the piezoelectric actuator substrate 21 to polarize the piezoelectric ceramic layer 21b.

Next, for electrically connecting the piezoelectric actuator substrate 21 and the control circuit 100, an Ag paste is printed on the connection land 26 of the piezoelectric actuator substrate 21, and allowed to set by heating to form the connection bump 27. On the connection bump 27, a FPC which is the signal transmission part 92 in which a driver IC is preliminarily mounted is placed, and pressed, and as a result the connection land 27 penetrates the cover film 92c and electrically connects with the wiring 92b. For mounting the driver IC, after it is flip-chip connected to the FPC by a solder, a protective resin was supplied around the solder and caused to cure.

Then, a reservoir is adhered as is needed so as to allow supply of liquid from the opening 5a, and the metal housing is screw-fixed, and then the joint is sealed with a sealing agent. In this way, the liquid discharge head 2 can be manufactured.

### REFERENCE SIGN LIST

1 printer
2 liquid discharge head
2a head body
4 flow passage member
4a to 4m plate (of flow passage member)
5 manifold (common flow passage)
5a opening (of manifold)
5b submanifold
6 aperture
8 discharge hole
9 discharge hole array
10 pressurizing chamber
11 pressurizing chamber array
12 individual flow passage
14 individual supply flow passage
15 partition wall
16 dummy pressurizing chamber
21 piezoelectric actuator substrate
21a piezoelectric ceramic layer (diaphragm)
21b piezoelectric ceramic layer
24 common electrode
25 individual electrode
25a individual electrode body
25b extraction electrode
26 connection land
27 connection bump
28 common electrode use surface electrode
30 displacement element
36, 36A dummy connection land
92 signal transmission part
92a, 92b cover film
92c wiring
D1 first region (of piezoelectric actuator substrate)
D2 second region (of piezoelectric actuator substrate)

1. A liquid discharge head comprising:
a flow passage member laminated a plurality of flat plates, including a plurality of pressurizing chambers opening in a plane, a plurality of discharge holes respectively connecting with a plurality of the pressurizing chambers, and a common flow passage commonly connecting with a plurality of the pressurizing chambers; and
a piezoelectric actuator substrate laminated on the plane of the flow passage member, disposed with a plurality of displacement elements, each displacement element containing at least one piezoelectric ceramic layer and a pair of electrodes disposed on each side with the piezoelectric ceramic layer interposed therebetween, wherein
on one principal plane of the piezoelectric actuator substrate, a plurality of connection electrodes to which respective driving signals of a plurality of the displacement elements are supplied are disposed, and
the number of the connection electrodes per unit area disposed in a first region that is a region not overlapping the common flow passage of the one principal plane, in a planar view of the liquid discharge head is greater than the number of the connection electrodes per unit area disposed in a second region that is a region overlapping the common flow passage of the one principal plane.

2. A liquid discharge head comprising:
a flow passage member laminated a plurality of flat plates, including a plurality of pressurizing chambers opening in a plane, a plurality of discharge holes respectively connecting with a plurality of the pressurizing chambers, and a common flow passage commonly connecting with a plurality of the pressurizing chambers; and
a piezoelectric actuator substrate laminated on the plane of the flow passage member, disposed with a plurality of displacement elements, each displacement element containing at least one piezoelectric ceramic layer and a pair of electrodes disposed on each side with the piezoelectric ceramic layer interposed therebetween, wherein
on one principal plane of the piezoelectric actuator substrate, a plurality of connection electrodes to which respective driving signals of a plurality of the displacement elements are supplied, and a plurality of dummy connection electrodes are disposed, and
the number of the dummy connection electrodes per unit area disposed in a first region that is a region not overlapping the common flow passage of the one principal plane, in a planar view of the liquid discharge head is greater than the number of the dummy connection electrodes per unit area disposed in a second region that is a region overlapping the common flow passage of the one principal plane.

3. A liquid discharge head comprising:
a flow passage member laminated a plurality of flat plates, including a plurality of pressurizing chambers opening in a plane, a plurality of discharge holes respectively connecting with a plurality of the pressurizing chambers, and a common flow passage commonly connecting with a plurality of the pressurizing chambers; and
a piezoelectric actuator substrate stacked on the plane of the flow passage member, disposed with a plurality of displacement elements, each displacement element containing at least one piezoelectric ceramic layer and a pair of electrodes disposed on each side with the piezoelectric ceramic layer interposed therebetween, wherein
on one principal plane of the piezoelectric actuator substrate, a plurality of connection electrodes to which respective driving signals of a plurality of the displacement elements are supplied, and a plurality of dummy connection electrodes are disposed, and
the number of the connection electrodes and the dummy connection electrodes per unit area disposed in a first region that is a region not overlapping the common flow passage of the one principal plane, in a planar view of the liquid discharge head is greater than the number of the connection electrodes and the dummy connection electrodes per unit area disposed in a second region that is a region overlapping the common flow passage of the one principal plane.

4. The liquid discharge head according to claim 2, wherein the dummy connection electrodes are disposed only in the first region.

5. The liquid discharge head according to claim 2, wherein the dummy connection electrodes disposed in the first region extend along a boundary between the first region and the second region.

6. The liquid discharge head according to claim 1, wherein when a distance from the one principal plane of the piezoelectric actuator substrate to the common flow passage is represented as h [mm], the connection electrodes disposed in the first region in a planar view of the liquid discharge head are disposed at a distance of h [mm] or more from a boundary between the first region and the second region.

7. The liquid discharge head according to claim 2, wherein when a distance from the one principal plane of the piezoelectric actuator substrate to the common flow passage is represented as h [mm], the dummy connection electrodes disposed in the first region in a planar view of the liquid discharge head are disposed at a distance of h [mm] or more from a boundary between the first region and the second region.

8. The liquid discharge head according to claim 1, wherein the connection electrodes disposed in the second region in a planar view of the liquid discharge head are disposed at positions closer to a lateral wall of the common flow passage than the center in the width direction of the common flow passage.

9. A recording device comprising: the liquid discharge head according to claim 1; a transport section for transporting a recording medium to the liquid discharge head; and a control section for controlling the liquid discharge head.

10. A piezoelectric actuator substrate for a liquid discharge head comprising: disposed with a plurality of displacement elements, each displacement element containing at least one piezoelectric ceramic layer and a pair of electrodes disposed on each side with the piezoelectric ceramic layer interposed therebetween, wherein
on one principal plane of the piezoelectric actuator substrate, a plurality of connection electrodes to which respective driving signals of a plurality of the displacement elements are supplied are disposed, and the one principal plane is divided into a first region not overlapping a common flow passage when it is used in the liquid discharge head and a second region overlapping the same, and
the number of the connection electrodes per unit area disposed in the first region is greater than the number of the connection electrodes per unit area disposed in the second region.

11. The liquid discharge head according to claim 2, wherein when a distance from the one principal plane of the piezoelectric actuator substrate to the common flow passage is represented as h [mm], the connection electrodes disposed in the first region in a planar view of the liquid discharge head are disposed at a distance of h [mm] or more from a boundary between the first region and the second region.

12. A recording device comprising: the liquid discharge head according to claim 2; a transport section for transporting a recording medium to the liquid discharge head; and a control section for controlling the liquid discharge head.

13. The liquid discharge head according to claim 3, wherein the dummy connection electrodes are disposed only in the first region.

14. The liquid discharge head according to claim 3, wherein the dummy connection electrodes disposed in the first region extend along a boundary between the first region and the second region.

15. The liquid discharge head according to claim 3, wherein when a distance from the one principal plane of the piezoelectric actuator substrate to the common flow passage is represented as h [mm], the connection electrodes disposed in the first region in a planar view of the liquid discharge head are disposed at a distance of h [mm] or more from a boundary between the first region and the second region.

16. The liquid discharge head according to claim 3, wherein when a distance from the one principal plane of the piezoelectric actuator substrate to the common flow passage is represented as h [mm], the dummy connection electrodes disposed in the first region in a planar view of the liquid discharge head are disposed at a distance of h [mm] or more from a boundary between the first region and the second region.

17. The liquid discharge head according to claim 3, wherein the connection electrodes disposed in the second region in a planar view of the liquid discharge head are disposed at positions closer to a lateral wall of the common flow passage than the center in the width direction of the common flow passage.

18. A recording device comprising: the liquid discharge head according to claim 3; a transport section for transporting a recording medium to the liquid discharge head; and a control section for controlling the liquid discharge head.
